(19) United States
(12) Patent Application Publication
(10) Pub. No.: US 2026/0254097 A1
(43) Pub. Date: Aug. 27, 2026

(54) ANTENNA MODULE AND MANUFACTURING METHOD OF DISPLAY DEVICE HAVING THE ANTENNA MODULE

(71) Applicant: Getac Technology Corporation, New Taipei City (TW)

(72) Inventor: Kuo-Hsiang LO, Taipei City (TW)

(21) Appl. No.: 19/296,830

(22) Filed: Aug. 11, 2025

(30) Foreign Application Priority Data
Feb. 24, 2025 (CN) 202510202860.1

(51) Int. Cl. H01Q 1/24; H01Q 1/36; H01Q 1/48

(52) U.S. Cl. CPC H01Q 1/243; H01Q 1/36; H01Q 1/48

(57) ABSTRACT

An antenna module includes multiple frame sections and at least one antenna structure. The antenna structure is connected with the frame sections. The antenna structure is located at a corner of the antenna module and includes at least three branches, and the branches extend along a first direction, a second direction, and a third direction that form the corner.

### CROSS - REFERENCE TO RELATED APPLICATION

This application claims priority to China Application Serial Number 202510202860.1, filed February 24, 2025, which is herein incorporated by reference in its entirety.

### BACKGROUND

### Field of Invention

The present invention relates to an antenna module and a manufacturing method of an antenna module.

### Description of Related Art

The current design of display devices pursues high screen-to-body ratio and narrow border, and therefore the space available for mounting antennas is reduced, which makes it difficult to meet the current design requirements of seven antennas for fifth generation mobile communications.

In view of this, how to provide a display device capable of increasing the number of antennas is still one of the goals that urgently need to be developed.

### SUMMARY

The invention provides an antenna module.

In one embodiment, the antenna module includes multiple frame sections and at least one antenna structure. The at least one antenna structure is connected with the frame sections. The at least one antenna structure is located at a corner of the antenna module and includes at least three branches, and the at least three branches extend along a first direction, a second direction, and a third direction that form the corner.

Another aspect of the present disclosure is a manufacturing method of a display device having an antenna structure.

In one embodiment, the manufacturing method of the display device having the antenna structure includes providing a back panel of the display device; disposing a central frame on the back panel, wherein the central frame includes a top surface, a first side surface and a second side surface connected together; and performing a metal processing to the central frame to form multiple frame sections and at least one antenna structure connected together, wherein the at least one antenna structure is located at a corner of the antenna module and includes at least three branches, and the at least three branches extend along three directions that define the corner.

In the aforementioned embodiments, the antenna module of the present disclosure can utilize the unused parts of the frame body of the display device as an antenna to form integral frame sections and the antenna structure. With such methods, the number of the antennas of the display device can be increased within the same equipment space, thereby improving space utilization. Moreover, the radiation path of the antenna structure is a stereoscopic design and contains multiple surfaces of the frame body, and therefore the antenna structure can achieve optimal radiation efficiency and field pattern.

### BRIEF DESCRIPTION OF THE DRAWINGS

The invention can be more fully understood by reading the following detailed description of the embodiment, with reference made to the accompanying drawings as follows:

FIG. 1 is a top view of a display device according to one embodiment of the present embodiment.

FIG. 2 is a partial schematic diagram of a central frame according to one embodiment of the present embodiment.

FIG. 3 is a schematic diagram of the antenna module in FIG. 2.

FIG. 4 is a schematic diagram from another viewpoint of FIG. 3.

FIG. 5 is a schematic diagram of the antenna structure in FIG. 3.

FIG. 6 is a schematic diagram from another viewpoint of FIG. 5.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

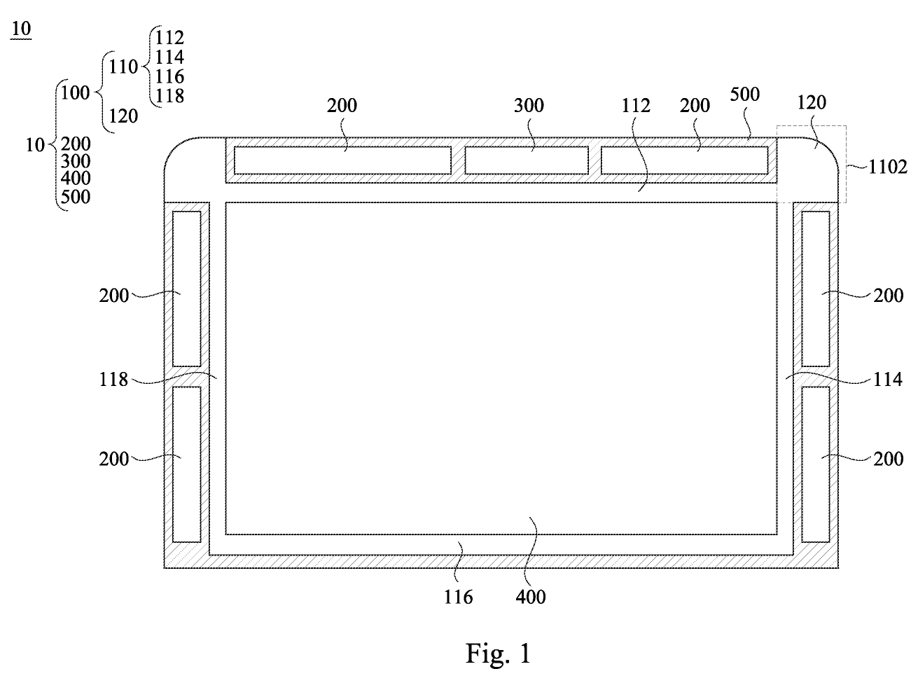

FIG. 1 is a top view of a display device 10 according to one embodiment of the present embodiment. The display device 10 includes an antenna module 100, multiple mounted antenna 200, a camera 300, and a back panel 400. The antenna module 100, the mounted antenna 200, and the camera 300 are disposed on the back panel 400. The antenna module 100 includes four frame sections 110 and at least one antenna structure 120. The antenna structure 120 is connected with the frame sections 110 and forms an integral frame body. The antenna structure 120 is located at a corner 1102 of the antenna module 100. In the present embodiment, the antenna module 100 of the display device 10 includes one antenna structure 120. In other embodiments, the antenna module 100 may include multiple antenna structures 120 disposed at other corners 1102 of the frame body. The frame sections 110 include a first frame section 112, a second frame section 114, a third frame section 116, and a fourth frame section 118.

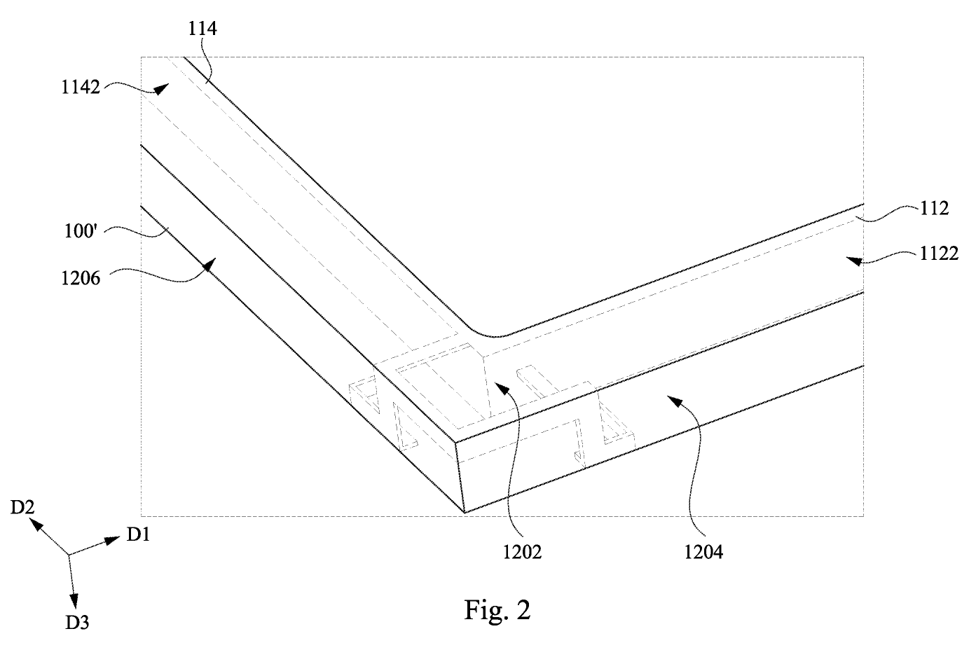

FIG. 2 is a top view of a central frame 110’ according to one embodiment of the present embodiment. The central frame 110’ used to form the antenna structure 120 and the frame sections 110 are illustrated by solid lines. The structural detail of the antenna structure 120 is illustrated by dashed lines. The material of the central frame 110’ is metal, and the frame body after the antenna structure 120 is formed is an integral metal frame which has the abilities to support the display device 10 and communicate with the antennas simultaneously. The antenna structure 120 is a remaining branched structure after the material of the central frame 110’ is partially removed. The central frame 110’ includes a top surface 1202, a first side surface 1204, and a second side surface 1206 connected together. These three surfaces extend along three different directions respectively, and are partially remained to form the antenna structure 120.

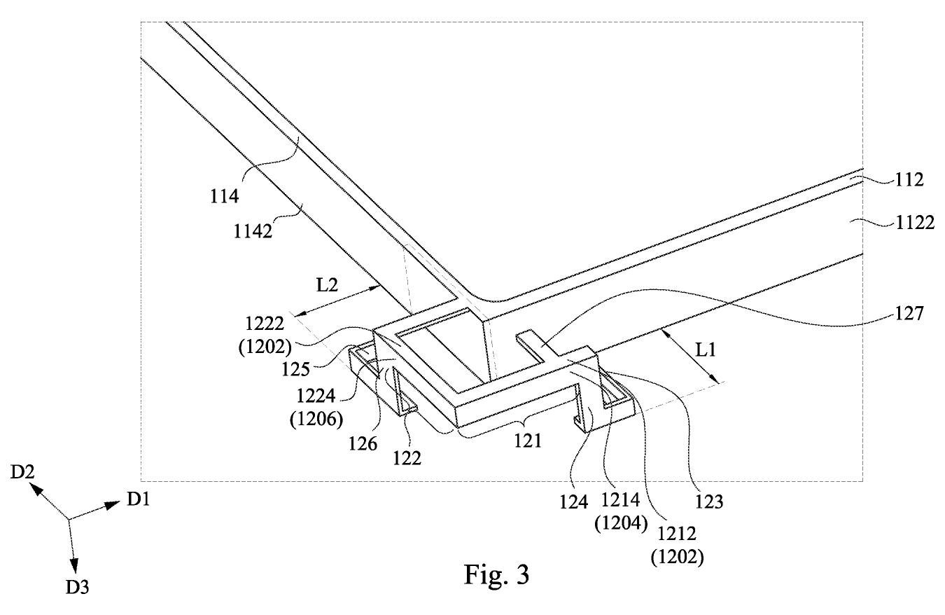

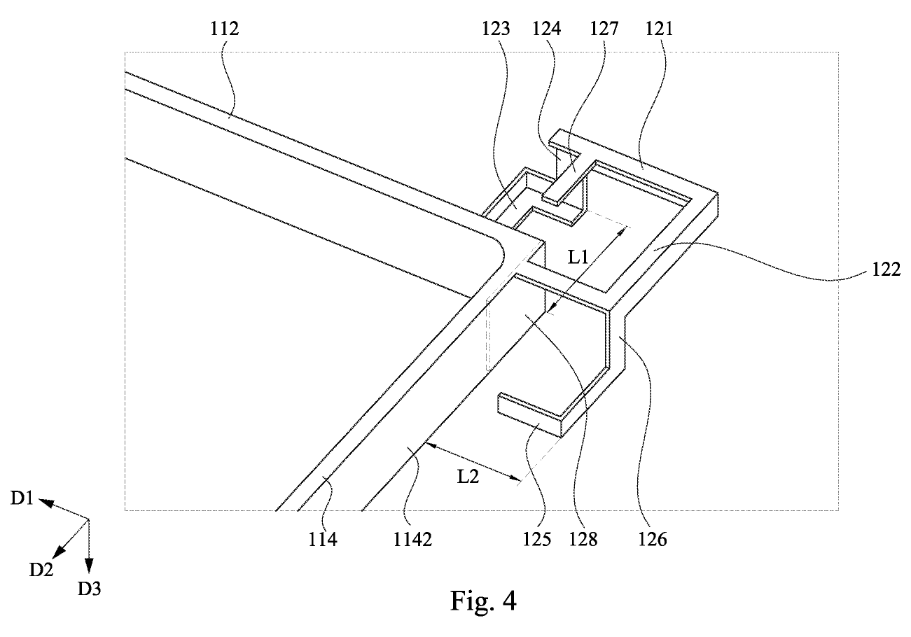

FIG. 3 is a schematic diagram of the antenna module 100 in FIG. 2. FIG. 4 is a schematic diagram from another viewpoint of FIG. 3. The antenna structure 120 includes a top surface 1202, a first side surface 1204, and a second side surface 1206 that form the corner 1102, which are equivalent to the outermost surfaces of the central frame 110’ shown in FIG. 2.

The antenna structure 120 includes at least three branches, and the branches extend along three directions that define the corner 1102 of the antenna module 100. As shown in FIG. 3 and FIG. 4, the branches of the antenna structures 120 extend along the first direction D1, the second direction D2, and the third direction D3 that are different with each other. In the present embodiment, the first direction D1, the second direction D2, and the third direction D3 are orthogonal to each other, but the present disclosure is not limited thereto.

In the present embodiment, the branches of the antenna structure 120 include a first branch 121 and a second branch 122. The first branch 121 extends along the first direction D1 and includes a first surface 1212 connected with a second surface 1214. The first surface 1212 is a first part of the top surface 1202, and the second surface 1214 is a part of the first side surface 1204. The second branch 122 extends along the second direction D2 and is connected with the first branch 121. The second branch 122 includes a third surface 1222 connected with a fourth surface 1224, the third surface 1222 is a second part of the top surface 1202, and the fourth surface 1224 is a part of the second side surface 1206.

The antenna structure 120 further includes a third branch 123, a fourth branch 124, a fifth branch 125, and a sixth branch 126. The third branch 123 extends along the second direction D2 from the first side surface 1204 towards the third side surface 1122. The third branch 123 is used as a high frequency radiation path. The fourth branch 124 is connected with the first branch 121 and the third branch 123 and extends along a third direction D3. For example, when the antenna structure 120 is a global navigation system (GNSS) antenna, the high frequency is in a range from 1565 MHz to 1612 MHz. When the antenna structure 120 is a Wi-Fi antenna, the high frequency is in a range from 5150 MHz to 7125 MHz.

The fourth branch 124 is formed by a part of the first side surface 1204. The structure of the third branch 123 corresponds to the space between the first side surface 1204 to the third side surface 1122 of the central frame 110’, but not a part of the first side surface 1204. In other words, the third branch 123 is a remaining portion of the central frame 110’ after the central frame 110’ is hollowed. A first distance L1 is presented between the first side surface 1204 and the third side surface 1122, and the length of the third branch 123 is smaller than the first distance L1.

The fifth branch 125 extends along the first direction D1 from the second side surface 1206 towards the fourth side surface 1142. The fifth branch 125 is used as a low frequency radiation path. The sixth branch 126 connects the second branch 122 and the fifth branch 125 and extends along the third direction D3. For example, when the antenna structure 120 is a global navigation system (GNSS) antenna, the low frequency is in a range from 1166 MHz to 1186 MHz. When the antenna structure 120 is a Wi-Fi antenna, the low frequency is in a range from 2400 MHz to 2500 MHz.

The sixth branch 126 is formed by a part of the second side surface 1206. The structure of the fifth branch 125 corresponds to the space between the second side surface 1206 to the fourth side surface 1142 of the central frame 110’, but not a part of the second side surface 1206. In other words, the fifth branch 125 is a remained portion of the central frame 110’ after been hollowed. A second distance L2 is presented between the second side surface 1206 and the fourth side surface 1142, and the length of the fifth branch 125 is smaller than the second distance L2.

The antenna structure 120 further includes a feed-in structure 127 extending from the first frame section 112 towards a third side surface 1122 of the first branches 121. The length of the feed-in structure 127 is smaller than the first distance L1.

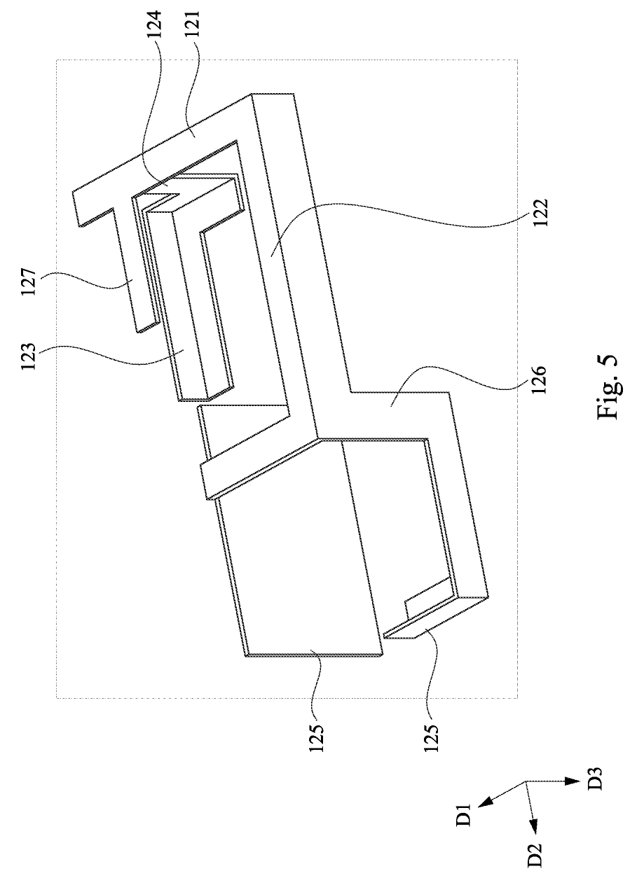

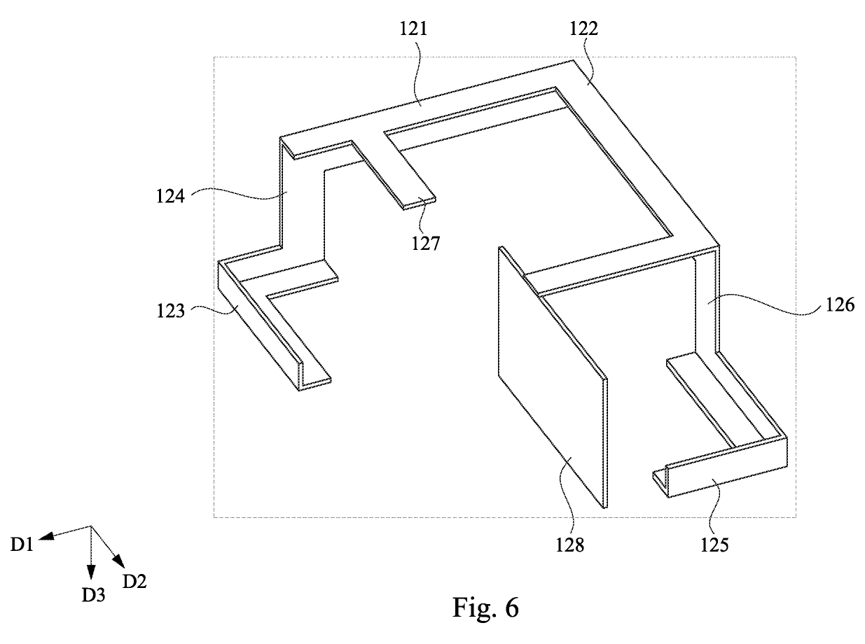

FIG. 5 is a schematic diagram of the antenna structure 120 in FIG. 3. FIG. 6 is a schematic diagram from another viewpoint of FIG. 5. The antenna structure 120 further includes a ground surface 128 connected with the second branch 122 and the fourth side surface 1142 (see FIG. 3) of the second frame section 114.

Reference is made to FIG. 1. The display device 10 is an electronic device with a high screen-to-body ratio and a narrow border design, such as a laptop. The display device 10 involves fifth generation mobile communication, and therefore seven antennas are required. Six mounted antennas 200 and the camera 300 are mounted to an outer side of the first frame section 112, the second frame section 114, and the third frame section 116 through the adhesive layer 500. The number of the antennas can be increased and the antenna structure 120 can be used as the seventh antenna by integrally forming the antenna structure 120 at the corner 1102 of the antenna module 100. For example, the antenna structure 120 can be a miniaturized wireless local area network (WLAN) or a global positioning system (GPS) antenna. The mounted antenna 200 may be a wireless wide area network (WWAN), a multiple-input multiple-output system (MIMO), and a global navigation system (GNSS).

The first branch 121 and the second branch 122 of the antenna structure 120 are formed by using three surfaces of the corner of the central frame 110’. The third branch 123 and the fifth branch 125 of the antenna structure 120 are formed by using the inner space of the central frame 110’. In other words, the antenna structure 120 can have multiple branches extending along the first direction D1, the second direction D2, and the third direction D3 simultaneously. Accordingly, the antenna module 100 of the present disclosure can utilize the unused part of the frame body of the display device 10 as an antenna. As such, the radiation path of the antenna structure 120 is a stereoscopic design and contains multiple surfaces of the frame body, and therefore the antenna structure 120 can has great radiation efficiency and field pattern.

It is noted that the connection relationship, materials, and functions of the components that have been described will not be repeated. In the following description, a manufacturing method of a display device having an antenna structure will be described.

Reference is made to FIG. 1. The manufacturing method begins with providing a back panel 400 of the display device 10. Reference is made to FIGS. 1 and 2. The central frame 110’ is subsequently disposed on the back panel 400. The central frame 110’ includes a top surface 1202, a first side surface 1204, and a second side surface 1206 connected together.

Reference is made to FIGS. 2 and 3. Continuously, a metal processing is performed to the central frame 110’ to form multiple frame sections 110 and at least one antenna structure 120 connected together. The metal processing is operated by computer numerical control (CNC) machines. With the aforementioned steps, the manufacturing of the integral frame sections 110 and the antenna structure 120 is finished. With such method, the number of the antennas of the display device 10 can be increased within the same machine operation space, thereby improving space utilization.

Lastly, the manufacturing method continues to mount the mounted antenna 200 and the camera 300 to the antenna module 100 which already contains the antenna structure 120. Therefore, the antenna structure 120 of the present disclosure does not require extra mounting steps and cost. Instead, the antenna structure 120 of the present disclosure can be manufactured when the frame body of the display device is formed simultaneously, thereby having the advantages of reducing steps and cost.

The step of performing the metal processing to the central frame 110’ to form multiple frame sections 110 and the at least one antenna structure 120 connected together may include partially removing the first side surface 1204 of the central frame 110’ to form the third side surface 1122 of the first frame section 112 of the frame sections 110 and partially removing the second side surface1206 of the central frame 110’ to form the fourth side surface 1142 of the second frame section 114 of the frame sections 110.

The step of performing the metal processing to the central frame 110’ to form multiple frame sections 110 and the at least one antenna structure 120 connected together may include forming the aforementioned first branch 121, the second branch 122, the third branch 123, the fourth branch 124, the fifth branch 125, and the sixth branch 126.

After determining the structures of the multiple branches of the antenna structure 120, the multiple steps above are substantially performed simultaneously in the same metal processing step. In some embodiment, the antenna module 100 includes multiple antenna structures 120. The forming steps of those antenna structures 120 are included in the same step. Therefore, the operation method of the present disclosure can improve screen-to-body ratio and the number of the antennas of a display device with narrow border design without extra mounting steps and cost.

In summary, the antenna module of the present disclosure can utilize the unused parts of the frame body of the display device as an antenna to form the integral frame sections and the antenna structure. With such methods, the number of the antennas of the display device can be increased within the same equipment space, thereby improving space utilization. Moreover, the radiation path of the antenna structure is a stereoscopic design and contains multiple surfaces of the frame body, and therefore the antenna structure can achieve optimal radiation efficiency and field pattern. The operation methods of the present disclosure can improve the screen-to-body ratio and the number of the antennas of a display device with narrow border design without extra mounting steps and costs.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An antenna module, disposed on a display device, wherein the antenna module comprises:
a plurality of frame sections; and
at least one antenna structure connected with the plurality of frame sections, wherein the at least one antenna structure is located at a corner of the antenna module and comprises at least three branches, and the at least three branches extend along a first direction, a second direction, and a third direction that define the corner.

2. The antenna module of claim 1, wherein the first direction, the second direction, and the third direction are different from each other.

3. The antenna module of claim 1, wherein a material of the antenna module is metal.

4. The antenna module of claim 1, wherein the at least one antenna structure comprises a top surface, a first side surface and a second side surface that form the corner, and the at least three branches of the at least one antenna structure comprise:
a first branch extending along the first direction and comprising a first surface connected with a second surface, wherein the first surface is a first part of the top surface, and the second surface is a part of the first side surface; and
a second branch extending along the second direction and connected with the first branch, wherein the second branch comprises a third surface connected with a fourth surface, the third surface is a second part of the top surface, and the fourth surface is a part of the second side surface.

5. The antenna module of claim 4, wherein the plurality of frame sections comprise:
a first frame section comprising a third side surface; and
a second frame section connected with the first frame section, wherein the second frame section comprises a fourth side surface connected with the third side surface.

6. The antenna module of claim 5, wherein the third side surface of the first frame section and the first side surface of the at least one antenna structure have a distance therebetween.

7. The antenna module of claim 5, wherein the fourth side surface of the second frame section and the second side surface of the at least one antenna structure have a distance therebetween.

8. The antenna module of claim 5, wherein the at least one antenna structure further comprises:
a feed-in structure extending from the first frame section towards the third side surface of the first branch.

9. The antenna module of claim 5, wherein the at least one antenna structure further comprises:
a ground surface connected with the second branch and the fourth side surface of the second frame section.

10. The antenna module of claim 5, further comprising:
a third branch extending along the second direction from the first side surface towards the third side surface, wherein the third branch is used as a high frequency radiation path.

11. The antenna module of claim 10, further comprising:
a fourth branch connected with the first branch and the third branch and extending along the third direction.

12. The antenna module of claim 5, further comprising:
a fifth branch extending along the first direction from the second side surface towards the fourth side surface, wherein the fifth branch is used as a low frequency radiation path.

13. The antenna module of claim 12, further comprising:
a sixth branch connected with the second branch and the fifth branch and extending along the third direction.

14. A manufacturing method of a display device having an antenna structure, comprising:
providing a back panel of the display device;
disposing a central frame on the back panel, wherein the central frame comprises a top surface, a first side surface, and a second side surface connected together; and
performing a metal processing to the central frame to form a plurality of frame sections and at least one antenna structure connected together, wherein the at least one antenna structure is located at a corner of the central frame and comprises at least three branches, and the at least three branches extend along three directions that define the corner.

15. The manufacturing method of the display device having the antenna structure of claim 14, further comprising:
disposing a plurality of antenna modules on the plurality of frame sections.

16. The manufacturing method of the display device having the antenna structure of claim 14, wherein performing the metal processing to the central frame to form the plurality of frame sections and the at least one antenna structure connected together comprises:
partially removing the first side surface of the central frame to form a third side surface of a first frame section of the plurality of frame sections; and
partially removing the second side surface of the central frame to form a fourth side surface of a second frame section of the plurality of frame sections.

17. The manufacturing method of the display device having the antenna structure of claim 16, wherein performing the metal processing to the central frame to form the plurality of frame sections and the at least one antenna structure connected together further comprises:
partially removing the central frame to form a first branch of the at least three branches extending along a first direction of the three directions and a second branch of the at least three branches extending along a second direction of the three directions, and the first branch is connected with the second branch.

18. The manufacturing method of the display device having the antenna structure of claim 17, wherein performing the metal processing to the central frame to form the plurality of frame sections and the at least one antenna structure connected together further comprises:
forming a feed-in structure such that the feed-in structure extends from the first branch towards the third side surface of the first frame section and connects to the third side surface; and
forming a ground surface, wherein the ground surface connects the second branch and the fourth side surface of the second frame section.

19. The manufacturing method of the display device having the antenna structure of claim 18, wherein performing the metal processing to the central frame to form the plurality of frame sections and the at least one antenna structure connected together further comprises:
forming a third branch of the at least three branches extending along the second direction, such that the third branch extends along the second direction from the first side surface towards the third side surface and is used as a high frequency radiation path; and
forming a fourth branch of the at least three branches extending along a third direction of the three directions and connecting the first branch and the third branch.

20. The manufacturing method of the display device having the antenna structure of claim 19, wherein performing the metal processing to the central frame to form the plurality of frame sections and the at least one antenna structure connected together further comprises:
forming a fifth branch of the at least three branches extending along the first direction, such that the fifth branch extends along the first direction from the second side surface towards the fourth side surface and is used as a low frequency radiation path; and
forming a sixth branch of the at least three branches extending along the third direction and connecting the second branch and the fifth branch.
